(19) United States
(12) Patent Application Publication
(10) Pub. No.: US 2025/0242539 A1
(43) Pub. Date: Jul. 31, 2025

(54) ELASTIC ADDITIVE MANUFACTURING WITH INTEGRATED THREE DIMENSIONAL REINFORCEMENT

(71) Applicants: Airbus Americas, Inc., Mobile, AL (US); Airbus Operations GmbH, Hamburg (DE)

(72) Inventors: Michael Telkamp, Hamburg (DE); Brent Clothier, Providence, RI (US); Jeffrey Nangle, Wichita, KS (US)

(21) Appl. No.: 18/427,330

(22) Filed: Jan. 30, 2024

(51) Int. Cl. B29C 64/165; B29C 64/245; B29C 64/264; B29C 64/393; B33Y 10/00; B33Y 30/00; B33Y 50/02

(52) U.S. Cl. CPC B29C 64/165; B29C 64/245; B29C 64/264; B29C 64/393; B33Y 10/00; B33Y 30/00; B33Y 50/02

(57) ABSTRACT

A system for making a finished component having a three-dimensional (3D) reinforcement integrally formed within a cured additive manufacturing fluid via an additive manufacturing process. The system includes a transport having the 3D reinforcement attached thereto, the transport being used to at least partially immerse the 3D reinforcement within the additive manufacturing fluid in an uncured state; an energy source that emits energy, which changes the additive manufacturing fluid from an uncured state to a cured state, to a focal point; and a controller that controls a position of the focal point to pass over at least a portion of an outer surface of the 3D reinforcement according to a curing pattern, changing the additive manufacturing fluid from the uncured state to the cured state on the portion of the outer surface of the 3D reinforcement defined by the curing pattern as the curing pattern is executed by the controller.

### TECHNICAL FIELD

The disclosure herein relates to systems and methods for additively manufacturing a component formed from an elastic material, with a three-dimensional reinforcing material integrated therein.

### BACKGROUND

Reinforcing materials are embedded within elastomeric materials to control the mechanical properties of the resultant components. However, such reinforced elastomeric parts are not manufactured using additive manufacturing. At present, elastomeric additively manufactured parts are made using elastomeric filaments or from thermoset (or similar) materials that are hardened by exposure to an energy source, such as ultraviolet (UV) light, chemical reaction, gamma rays, etc. However, elastomeric components having three-dimensional reinforcing materials have not yet been able to be produced using additive manufacturing techniques, instead typically being manufactured using processes such as, for example, molding, cross section extrusion, and the like. However, the inability to embed a three-dimensional reinforcing material, such as a woven material formed from a plurality of interwoven fibers, within some or all portions of such elastomeric components formed via additive manufacturing has limited the ability to control the mechanical properties of elastomeric components with three-dimensional reinforcing materials integrated therein via additive manufacturing.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later.

In an example embodiment, a system is disclosed herein for making a finished component having a three-dimensional (3D) reinforcement integrally formed within a cured additive manufacturing fluid via an additive manufacturing process. In this example embodiment, the system comprises a transport configured to have the 3D reinforcement attached thereto and to at least partially immerse the 3D reinforcement within the additive manufacturing fluid in an uncured state; an energy source configured to emit energy to a focal point, the energy being configured to change the additive manufacturing fluid from the uncured state to a cured state; and a controller configured to control a position of the focal point to pass over at least a portion of an outer surface of the 3D reinforcement according to a curing pattern, changing the additive manufacturing fluid from the uncured state to the cured state on the portion of the outer surface of the 3D reinforcement defined by the curing pattern as the curing pattern is executed by the controller.

In some embodiments of the system, the transport comprises a build plate that suspends the 3D reinforcement attached thereto within the additive manufacturing fluid.

In some embodiments, the system comprises a second energy source with an emitter configured to emit energy to a second focal point, the energy being configured to change the additive manufacturing fluid from the uncured state to the cured state. In such embodiments, the build plate comprises a hole; and the emitter is configured to extend through the hole, into a volumetric region defined within the 3D reinforcement, for curing the additive manufacturing fluid over some or all of an inner surface of the 3D reinforcement.

In some embodiments of the system, the transport comprises a plurality of build plates that are attached in an end-to-end manner, the transport being configured to sequentially immerse the 3D reinforcement attached to each of the plurality of build plates within the additive manufacturing fluid.

In some embodiments, the system comprises a basin containing the additive manufacturing fluid in the uncured state; and a roller configured to guide the plurality of build plates of the transport sequentially into the additive manufacturing fluid and through a region in the basin in which the energy is directed for curing the additive manufacturing fluid.

In some embodiments of the system, the energy comprises one or more of ultraviolet light, laser light, electromagnetic waves, electronic beam, and gamma rays.

In some embodiments, the system comprises a lens configured, when the energy is incident on the lens, to focus the energy to the focal point within the additive manufacturing fluid, so that the additive manufacturing fluid is changed from the uncured state to the cured state only at the focal point.

In some embodiments of the system, the controller is configured to move the 3D reinforcement, the lens, and/or the energy source so that the focal point moves over some or all of an outer surface of the 3D reinforcement to cure the additive manufacturing fluid over the outer surface of the 3D reinforcement.

In some embodiments of the system, the additive manufacturing fluid comprises a liquid polymer.

In some embodiments of the system, the 3D reinforcement comprises polymeric fibers and/or mesh, natural fibers and/or mesh, metal fibers and/or mesh, and mixtures thereof; and the 3D reinforcement is in a form of a knitted or woven fabric, a lay-up comprising a plurality of stacked layers, and/or as a welded structure.

In another example embodiment, a method is disclosed for making a finished component having a three-dimensional (3D) reinforcement integrally formed within a cured additive manufacturing fluid via an additive manufacturing process. According to this example embodiment, the method comprises providing a transport; attaching the 3D reinforcement to the transport; using the transport to at least partially immerse the 3D reinforcement within the additive manufacturing fluid in an uncured state; emitting energy from an energy source to a focal point to change the additive manufacturing fluid from the uncured state to a cured state; and controlling, using a controller, a position of the focal point to pass over at least a portion of an outer surface of the 3D reinforcement according to a curing pattern, changing the additive manufacturing fluid from the uncured state to the cured state on the portion of the outer surface of the 3D reinforcement defined by the curing pattern as the curing pattern is executed by the controller.

In some embodiments of the method, the transport comprises a build plate that suspends the 3D reinforcement attached thereto within the additive manufacturing fluid.

In some embodiments of the method, the build plate comprises a hole and the method comprises providing a second energy source with an emitter; extending the emitter through the hole, into a volumetric region defined within the 3D reinforcement; and emitting energy from the emitter to a second focal point to change the additive manufacturing fluid from the uncured state to the cured state over some or all of an inner surface of the 3D reinforcement.

In some embodiments of the method, the transport comprises a plurality of build plates that are attached in an end-to-end manner, the method comprising using the transport to sequentially immerse the 3D reinforcement attached to each of the plurality of build plates within the additive manufacturing fluid.

In some embodiments, the method comprises providing a basin containing the additive manufacturing fluid in the uncured state; and using a roller to guide the plurality of build plates of the transport sequentially into the additive manufacturing fluid and through a region in the basin in which the energy is directed for curing the additive manufacturing fluid.

In some embodiments of the method, the energy comprises one or more of ultraviolet light, laser light, electromagnetic waves, electronic beam, and gamma rays.

In some embodiments, the method comprises providing a lens; directing the energy from the energy source onto the lens; and using the lens focus the energy to the focal point within the additive manufacturing fluid, so that the additive manufacturing fluid is changed from the uncured state to the cured state only at the focal point.

In some embodiments, the method comprises using the controller to move the 3D reinforcement, the lens, and/or the energy source so that the focal point moves over some or all of an outer surface of the 3D reinforcement to cure the additive manufacturing fluid over the outer surface of the 3D reinforcement.

In some embodiments of the method, the additive manufacturing fluid comprises a liquid polymer.

In some embodiments of the method, the 3D reinforcement comprises polymeric fibers and/or mesh, natural fibers and/or mesh, metal fibers and/or mesh, and mixtures thereof; and the 3D reinforcement is in a form of a knitted or woven fabric, a lay-up comprising a plurality of stacked layers, and/or as a welded structure.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely an example of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

FIG. 1 is a schematic side view of an example embodiment of a system for additively manufacturing a component by curing an additive manufacturing fluid (e.g., a liquid polymer) on and/or in a three-dimensional reinforcing material suspended within a basin containing the additive manufacturing fluid.

FIG. 2 is a schematic side view of another example embodiment of a system for additively manufacturing a component by curing an additive manufacturing fluid (e.g., a liquid polymer) on and/or in a three-dimensional reinforcing material suspended within a basin containing the additive manufacturing fluid.

FIG. 3 is a schematic side view of yet another example embodiment of a system for additively manufacturing a component by curing an additive manufacturing fluid (e.g., a liquid polymer) on and/or in a three-dimensional reinforcing material as the reinforcing material moves through a basin containing the additive manufacturing fluid.

### DETAILED DESCRIPTION

In the description below, without being restricted hereto, specific details are presented in order to give a complete understanding of the disclosure herein. It is, however, clear to a person skilled in the art that the disclosure herein may be used in other example embodiments which may differ from the details outlined below. The figures serve furthermore merely to illustrate example embodiments, are not to scale, and serve merely to illustrate by example the general concept of the disclosure herein. For example, features contained in the figures must not necessarily be considered to be essential components.

Comparable or identical components and features, or those with similar effect, carry the same reference signs in the figures. For reasons of clarity, in the figures sometimes the reference signs of individual features and components have been omitted, wherein these features and components carry reference signs in the other figures.

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined herein, are intended to have the same meaning as commonly understood by one of ordinary skill in the art. References to techniques employed herein are intended to refer to the techniques as commonly understood in the art, including variations on those techniques or substitutions of equivalent techniques that would also be apparent to one of skill in the art. While the following terms are believed to be well understood by one of ordinary skill in the art, the following definitions are set forth to facilitate explanation of the presently disclosed subject matter.

In describing the presently disclosed subject matter, it should be understood that a number of techniques, features, steps, etc. are disclosed. Each of these has individual benefit and each can also be used in conjunction with one or more, or in some cases all, of the other disclosed techniques, features, steps, etc.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a vertical post” includes a plurality of such vertical posts, and so forth.

Unless otherwise indicated, all numbers expressing quantities of structures, features, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed devices, compositions, systems and/or methods.

The term “comprising,” which is synonymous with “including,” “containing,” and/or “characterized by,” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or feature not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

As used herein, the term “and/or,” when used in the context of a listing of entities, refers to the entities being present singly or in any combination. Thus, for example, the phrase “A, B, C, and/or D” includes A, B, C, and D individually, but also includes any and all combinations and subcombinations of A, B, C, and D.

It will be understood that various details of the presently disclosed subject matter may be changed without departing from the scope of the presently disclosed subject matter. Furthermore, the foregoing description is for the purpose of illustration only, and not for the purpose of limitation.

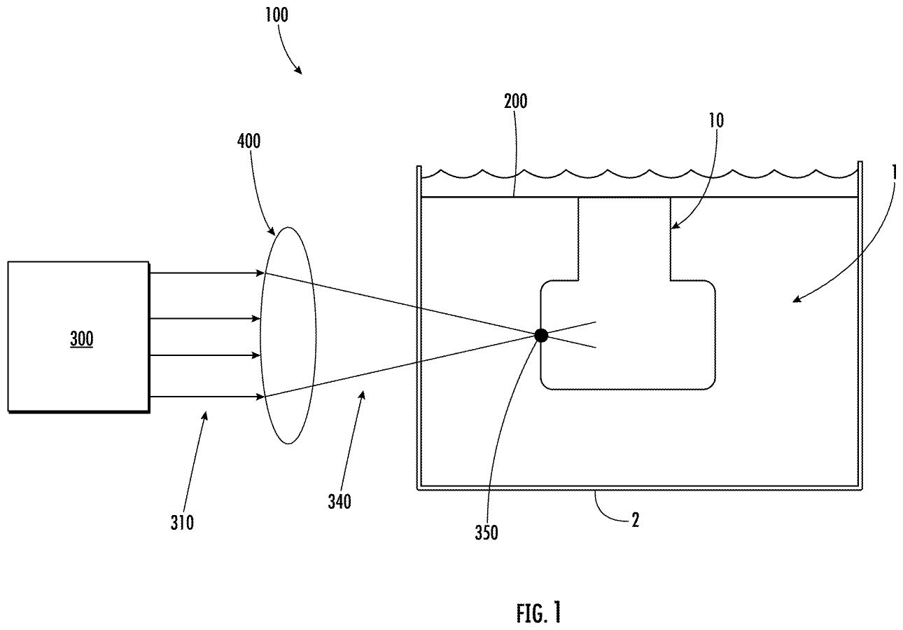

FIG. 1 is a side view of a first example embodiment of a system, generally designated 100, for directing energy, generally designated 310, from an energy source 300 to an additive manufacturing fluid, generally designated 1, for curing the additive manufacturing fluid 1 on and/or within a three-dimensional (3D) reinforcement 10 that is suspended within the additive manufacturing fluid 1. The 3D reinforcement 10 is formed to have a prescribed geometry based on the component being manufactured. The 3D reinforcement 10 is then attached to a build plate 200. The build plate is then positioned over and/or in a basin 2 containing the additive manufacturing fluid 1, such that some or all of the 3D reinforcement 10 is suspended within the additive manufacturing fluid 1. The additive manufacturing fluid 1 can be any suitable material for curing (e.g., changing from a liquid to a solid) by an energy source 300. For example, the additive manufacturing fluid 1 can be a liquid polymer. The type of additive manufacturing fluid 1 and the energy source 300 can be selected to complement each other, meaning that the energy source 300 must always be of a type that will cure (e.g., harden, solidify, or otherwise change from liquid to substantially solid or solid) the selected additive manufacturing fluid 1.

In the example embodiment shown, the energy source 300 emits unfocused energy, generally designated 310, which is directed incident on a lens 400. The lens 400 focuses the energy 310, producing focused energy, generally designated 340. During the curing process, the lens 400 is positioned such that the focused energy 340 has a focal point 350 that is within the basin 2. The basin 2 should be substantially transparent to the energy produced by the energy source 300, so that the basin 2 does not absorb the energy passing therethrough. During the curing process, a controller is used to control a position of the lens 400 so that the focal point 350 follows a curing pattern within the basin 2. The curing pattern is selected based on the shape of the 3D reinforcement 10 and the component being manufactured. In some embodiments, the curing pattern is predefined and does not necessarily detect or follow the shape of the 3D reinforcement 10, meaning that the curing pattern will be carried out regardless of whether a 3D reinforcement 10 that is not compatible with the curing pattern is selected or if the 3D reinforcement 10 is improperly attached (e.g., in the wrong position) to the build plate 200. In some embodiments, the curing pattern is selected based on a detection of the 3D reinforcement 10 by the controller, meaning that the controller will control the position of the focal point 350 to follow along the outer surface of the 3D reinforcement 10 within the basin 2 even if the 3D reinforcement 10 is, for example, improperly attached to the build plate 200. Thus, in some embodiments, the curing pattern can be dynamically controlled to follow the shape of the outer surface of the 3D reinforcement 10.

During the curing process, the curing pattern selected by the controller will generally control the position and angle of the lens 400 such that the focal point 350 is within the 3D reinforcement 10, on the outer surface of the 3D reinforcement 10, or on the outer surface of previously cured additive manufacturing fluid (e.g., that defines an outer surface of the 3D reinforcement 10). The controller moves the lens 400 so that the focal point 350 cures the additive manufacturing fluid 1 within and/or on the surface of the 3D reinforcement 10, so as to form a component or structure in which the cured additive manufacturing fluid 1 and the 3D reinforcement 10 are integrally formed with each other, meaning a monolithic or unitary construction in some instances. In some instances, rather than the position of the focal point 350 changing, such as may be achieved by adjusting the position of the lens 400, the controller is configured to move the 3D reinforcement 10 within the additive manufacturing fluid 1 so that the additive manufacturing liquid 1 is cured within different portions of the 3D reinforcement 10 as the controller moves the 3D reinforcement 10 so that the different portions of the 3D reinforcement 10 are within the focal point 350, causing curing of the additive manufacturing liquid 1 in such different portions as they move within the focal point 350. In some embodiments, the position of the focal point 350 within the basin 2 may be controlled by reflecting the focused energy 340 off of a reflective surface, such as a glass mirror, a polished metallic surface, etc.

The 3D reinforcement 10 has a shape and construction that is based on providing the component or structure being formed using the system 100 with a prescribed shape and mechanical properties. In some embodiments, the 3D reinforcement 10 is in the form of a reinforcement cage that encloses, partially or entirely, a volumetric region defined within the 3D reinforcement 10. The 3D reinforcement 10 can be, for example and without limitation, made from polymeric fibers and/or mesh, natural fibers and/or mesh, metal fibers and/or mesh, and mixtures of any of these materials. The various polymeric, natural, and/or metal fibers and meshes can form, for example, a knitted or woven material. In some embodiments, the various polymeric, natural, and/or metal fibers and meshes can be assembled in a layup manner (e.g., a series of stacked layers) and/or via any suitable welding processes.

The energy 310 produced by the energy source 300 can be, for example and without limitation, ultraviolet light, laser light, electromagnetic waves, and the like. The lens 400 can be an optical lens and/or a magnetic lens. The energy source 300 can produce any types of beams having energy that can be focused into a focal point 350 to enable local curing of the additive manufacturing fluid 1 in a controllable manner. The 3D reinforcement 10 can be transparent, translucent, or opaque to the energy 310 emitted from the energy source 300.

The system 100 also comprises sensors that are used to continuously monitor the curing process within the basin 2. Non-limiting examples of such sensors include cameras, scattered radiation detectors, and the like.

Thus, a method of using the system 100 to cure an additive manufacturing liquid integrally with a 3D reinforcement to produce a component or structure via an additive manufacturing process can include the following steps. In a first step, the 3D reinforcement 10 is manufactured to have a prescribed geometry and construction. This 3D reinforcement 10 can have electrical and/or sensing functions. The 3D reinforcement 10 can be formed from any of polymer fibers and/or mesh, natural fibers and/or mesh, and/or metal fibers and mesh. The 3D reinforcement 10 can be formed in the manner of a preform structure, such as using any of the following techniques: knitting, weaving, laying-up layers, and/or welding. After the 3D reinforcement 10 has been manufactured, the 3D reinforcement 10 is attached to the build plate 200. The build plate 200 is then positioned, relative to the basin 2 containing additive manufacturing fluid 1, such that the 3D reinforcement 10 is partially or entirely immersed within the additive manufacturing liquid 1 within the basin 2. In some instances, the build plate 200 is also immersed in the additive manufacturing liquid 1. The 3D reinforcement 10 can be impervious to the additive manufacturing liquid 1 or porous, allowing the additive manufacturing liquid 1 to pass through the 3D reinforcement 10 and into the volumetric region defined within the 3D reinforcement 10.

Next, the curing process is initiated by energizing an energy source 300 to provide energy 310, which is incident on a lens 400 that emits focused energy 340 that converges at a focal point 350 within the basin 2. The energy 310 emitted from the energy source 300 is of a type that will cure (e.g., harden, solidify, or otherwise change from liquid to substantially solid or solid) the additive manufacturing liquid 1 at the focal point 350. The additive manufacturing liquid 1 is cured at least on the outer surface of and/or within the 3D reinforcement 10. Examples of energy types provided by the energy source 300 include UV light, gamma rays, electronic beam, laser, etc. The lens 400 and/or the 3D reinforcement 10 are positioned relative to each other such that the focal point 350 is at a point on the surface of the 3D reinforcement 10 that is designated as a starting point in a curing pattern. Next, the lens 400 and/or the 3D reinforcement 10 are moved (e.g., relative to each other) such that the focal point 350 moves along the surface of the 3D reinforcement 10 according to the curing pattern. Sensors can be used to continuously monitor the curing of the additive manufacturing liquid 1.

After the curing pattern has been completed successfully, a finished component or structure is formed, in which the 3D reinforcement 10 is integrated within, at least partially, the cured additive manufacturing liquid 1. Next, the build plate 200, as well as the finished component attached thereto, is removed from the basin 2, as well as the remaining uncured additive manufacturing liquid 1 contained therein. Since the cured additive manufacturing liquid 1 may, after having been cured by the focused energy 340, be impervious to the remaining uncured additive manufacturing liquid 1, it may be necessary to drain any uncured additive manufacturing liquid 1 from the finished component after the build plate 200 and the finished component are removed from the basin 2. Finally, the finished component is removed from the build plate 200 and any necessary finishing steps are performed on the finished component as needed. These finishing steps include, optionally, any of exposing the finished component for final curing and trimming the finished part to remove any extraneous material based on the specification of the finished component.

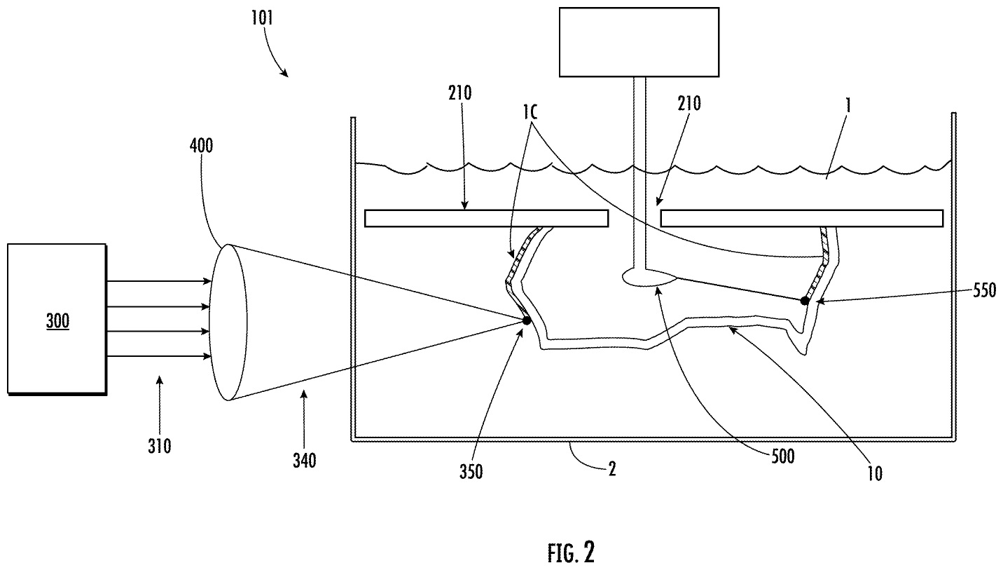

FIG. 2 is a side view of a second example embodiment of a system, generally designated 101, for directing energy, generally designated 310, from an energy source 300 to an additive manufacturing fluid, generally designated 1, for curing the additive manufacturing fluid 1 on and/or within a three-dimensional (3D) reinforcement 10 that is suspended within the additive manufacturing fluid 1. The 3D reinforcement 10 is formed to have a prescribed geometry based on the component being manufactured. The 3D reinforcement 10 is then attached to a build plate 200. The build plate is then positioned over and/or in a basin 2 containing the additive manufacturing fluid 1, such that some or all of the 3D reinforcement 10 is suspended within the additive manufacturing fluid 1. The additive manufacturing fluid 1 can be any suitable material for curing (e.g., changing from a liquid to a solid) by an energy source 300. For example, the additive manufacturing fluid 1 can be a liquid polymer. The type of additive manufacturing fluid 1 and the energy source 300 can be selected to complement each other, meaning that the energy source 300 must always be of a type that will cure (e.g., harden, solidify, or otherwise change from liquid to substantially solid or solid) the selected additive manufacturing fluid 1. The additive manufacturing fluid in a cured, or hardened, state is designated 1C.

In this example embodiment, the additive manufacturing liquid 1 is being cured both on the inner surface of the 3D reinforcement 10 and also on the outer surface of the 3D reinforcement 10. To accomplish this in instances in which the 3D reinforcement 10 is opaque to the energy 310 emitted by the energy source 300, it is necessary for the system 101 to have a second energy source 500 that extends to a position to cure the additive manufacturing liquid 1 on the inner surface of the 3D reinforcement. In the example shown in FIG. 2, the build plate 200 comprises a hole, generally designated 210, that allows passage of an energy emitter of the second energy source 500 through the hole and into the volumetric region defined within the 3D reinforcement 10. The energy emitter of the second energy source 500 emits energy that is directed and focused to define a second focal point, generally designated 550, that is incident on the inner surface of the 3D reinforcement 10. The second energy source 500 is operable independent of the energy source 300, such that the energy source 300 and the second energy source 500 can be operated simultaneously with each other to cure additive manufacturing fluid on the outer and inner surfaces, respectively, of the 3D reinforcement 10. The energy emitted by the second energy source 500 is advantageously the same type of energy as the energy 310 emitted by the energy source 300. The lenses necessary to form the second focal point 550 are provided as part of the second energy source 500.

In the example embodiment shown, the energy source 300 emits unfocused energy, generally designated 310, which is directed incident on a lens designated 340. During the curing process, the lens 400 is positioned such that the focused energy 340 has a focal point 350 that is within the basin 2. The basin 2 should be substantially transparent to the energy produced by the energy source 300, so that the basin 2 does not absorb the energy passing therethrough. During the curing process, a controller is used to control a position of the lens 400 so that the focal point 350 follows a curing pattern within the basin 2. The curing pattern is selected based on the shape of the 3D reinforcement 10 and the component being manufactured. In some embodiments, the curing pattern is predefined and does not necessarily detect or follow the shape of the 3D reinforcement 10, meaning that the curing pattern will be carried out regardless of whether a 3D reinforcement 10 that is not compatible with the curing pattern is selected or if the 3D reinforcement 10 is improperly attached (e.g., in the wrong position) to the build plate 200. In some embodiments, the curing pattern is selected based on a detection of the 3D reinforcement 10 by the controller, meaning that the controller will control the position of the focal point 350 to follow along the outer surface of the 3D reinforcement 10 within the basin 2 even if the 3D reinforcement 10 is, for example, improperly attached to the build plate 200. Thus, in some embodiments, the curing pattern can be dynamically controlled to follow the shape of the 3D reinforcement 10.

During the curing process, the controller is used to control a position of the emitter of the second energy source 500 so that the second focal point 550 follows a second curing pattern over the inner surface of the 3D reinforcement 10. The second curing pattern is selected based on the shape of the 3D reinforcement 10 and the component being manufactured. In some embodiments, the second curing pattern is predefined and does not necessarily detect or follow the shape of the 3D reinforcement 10, meaning that the second curing pattern will be carried out regardless of whether a 3D reinforcement 10 that is not compatible with the second curing pattern is selected or if the 3D reinforcement 10 is improperly attached (e.g., in the wrong position) to the build plate 200. In some embodiments, the second curing pattern is selected based on a detection of the 3D reinforcement 10 by the controller, meaning that the controller will control the position of the second focal point 550 to follow along the inner surface of the 3D reinforcement 10 within the basin 2 even if the 3D reinforcement 10 is, for example, improperly attached to the build plate 200. Thus, in some embodiments, the second curing pattern can be dynamically controlled to follow the shape of the inner surface of the 3D reinforcement 10.

In some instances, rather than the position of the second focal point 550 changing, such as may be achieved by adjusting the position or angle of the emitter of the second energy source 500, the controller is configured to move the 3D reinforcement 10 within the additive manufacturing fluid 1 so that the additive manufacturing liquid 1 is cured within different portions of the inner surface of the 3D reinforcement 10 as the controller moves the 3D reinforcement 10 so that the different portions of the inner surface of the 3D reinforcement 10 are within the second focal point 550, causing curing of the additive manufacturing liquid 1 in such different portions of the inner surface as these different portions move within the second focal point 550. In some embodiments, the position of the second focal point 550 within the basin 2 may be controlled by reflecting the energy emitted from the emitter of the second energy source 500 off of a reflective surface, such as a glass mirror, a polished metallic surface, etc.

During the curing process, the curing pattern selected by the controller will generally control the position and angle of the lens 400 such that the focal point 350 is within the 3D reinforcement 10, on the outer surface of the 3D reinforcement 10, or on the outer surface of previously cured additive manufacturing fluid (e.g., that defines an outer surface of the 3D reinforcement 10). The controller moves the lens 400 so that the focal point 350 cures the additive manufacturing fluid 1 within and/or on the surface of the 3D reinforcement 10, so as to form, along with the additive manufacturing liquid 1 cured on the inner surface of the 3D reinforcement, a component or structure in which the cured additive manufacturing fluid 1 and the 3D reinforcement 10 are integrally formed with each other, meaning a monolithic or unitary construction in some instances. In some instances, rather than the position of the focal point 350 changing, such as may be achieved by adjusting the position of the lens 400, the controller is configured to move the 3D reinforcement 10 within the additive manufacturing fluid 1 so that the additive manufacturing liquid 1 is cured within different portions of the 3D reinforcement 10 as the controller moves the 3D reinforcement 10 so that the different portions of the 3D reinforcement 10 are within the focal point 350, causing curing of the additive manufacturing liquid 1 in such different portions as they move within the focal point 350. In some embodiments, the position of the focal point 350 within the basin 2 may be controlled by reflecting the focused energy 340 off of a reflective surface, such as a glass mirror, a polished metallic surface, etc.

The operation of the energy source 300 and of the second energy source 500 during the curing process can be simultaneous (e.g., curing the additive manufacturing liquid 1 simultaneously on the inner and outer surfaces of the 3D reinforcement 10), sequential (e.g., curing the additive manufacturing liquid 1 on the inner surface of the 3D reinforcement 10 before or after curing the additive manufacturing liquid 1 on the outer surface of the 3D reinforcement 10), in an alternating manner, or in any suitable manner.

The 3D reinforcement 10 has a shape and construction that is based on providing the component or structure being formed using the system 100 with a prescribed shape and mechanical properties. In some embodiments, the 3D reinforcement 10 is in the form of a reinforcement cage that encloses, partially or entirely, a volumetric region defined within the 3D reinforcement 10. The 3D reinforcement 10 can be, for example and without limitation, made from polymeric fibers and/or mesh, natural fibers and/or mesh, metal fibers and/or mesh, and mixtures of any of these materials. The various polymeric, natural, and/or metal fibers and meshes can form, for example, a knitted or woven material. In some embodiments, the various polymeric, natural, and/or metal fibers and meshes can be assembled in a layup manner (e.g., a series of stacked layers) and/or via any suitable welding processes.

The energy 310 produced by the energy source 300 and the second energy source 500 can be, for example and without limitation, ultraviolet light, laser light, electromagnetic waves, and the like. The lens 400 can be an optical lens and/or a magnetic lens. The energy source 300 and the second energy source 550 can produce any types of beams having energy that can be focused into a focal point 350 and a second focal point 550, respectively, to enable local curing of the additive manufacturing fluid 1 on the outer and inner surfaces, respectively, of the 3D reinforcement 10 in a controllable manner. The 3D reinforcement 10 can be transparent, translucent, or opaque to the energy 310 emitted from the energy source 300.

The system 101 also comprises sensors that are used to continuously monitor the curing process within the basin 2. Non-limiting examples of such sensors include cameras, scattered radiation detectors, and the like.

Thus, a method of using the system 101 to cure an additive manufacturing liquid integrally with a 3D reinforcement to produce a component or structure via an additive manufacturing process can include the following steps. In a first step, the 3D reinforcement 10 is manufactured to have a prescribed geometry and construction. This 3D reinforcement 10 can have electrical and/or sensing functions. The 3D reinforcement 10 can be formed from any of polymer fibers and/or mesh, natural fibers and/or mesh, and/or metal fibers and mesh. The 3D reinforcement 10 can be formed in the manner of a preform structure, such as using any of the following techniques: knitting, weaving, laying-up layers, and/or welding. After the 3D reinforcement 10 has been manufactured, the 3D reinforcement 10 is attached to the build plate 200. The build plate 200 is then positioned, relative to the basin 2 containing additive manufacturing fluid 1, such that the 3D reinforcement 10 is partially or entirely immersed within the additive manufacturing liquid 1 within the basin 2. In some instances, the build plate 200 is also immersed in the additive manufacturing liquid 1. The 3D reinforcement 10 can be impervious to the additive manufacturing liquid 1 or porous, allowing the additive manufacturing liquid 1 to pass through the 3D reinforcement 10 and into the volumetric region defined within the 3D reinforcement 10.

To cure the inner surface of the 3D reinforcement 10, the build plate 200 has a hole 210 formed therein to allow the emitter of a second energy source 500 to extend within an internal volumetric region of the 3D reinforcement 10.

Next, a curing process is initiated, the curing process including an outer curing step and an inner curing step, which can be performed sequentially, simultaneous, in an alternating manner, etc. The outer curing step comprises energizing an energy source 300 to provide energy 310, which is incident on a lens 400 that emits focused energy 340 that converges at a focal point 350 within the basin 2. The energy 310 emitted from the energy source 300 is of a type that will cure (e.g., harden, solidify, or otherwise change from liquid to substantially solid or solid) the additive manufacturing liquid 1 at the focal point 350. The lens 400 and/or the 3D reinforcement 10 are moved relative to each other such that the additive manufacturing liquid 1 is cured by the focal point 350 at least on the outer surface of and/or within the 3D reinforcement 10. The inner curing step comprises energizing the second energy source 500 to provide energy that converges at a second focal point 550 on an inner surface of the 3D reinforcement. The energy emitted from the second energy source 500 is of a type that will cure (e.g., harden, solidify, or otherwise change from liquid to substantially solid or solid) the additive manufacturing liquid 1 at the second focal point 550. The emitter and/or the 3D reinforcement 10 are moved relative to each other such that the additive manufacturing liquid 1 is cured by the second focal point 550 at least partially or entirely over the inner surface of the 3D reinforcement 10.

Examples of energy types provided by the energy source 300 and the second energy source 500 include UV light, gamma rays, electronic beam, laser, etc. The lens 400 and/or the 3D reinforcement 10 are positioned relative to each other such that the focal point 350 is at a point on the outer surface of the 3D reinforcement 10 that is designated as a starting point in an outer curing pattern. The emitter of the second energy source 500 and/or the 3D reinforcement 10 are positioned relative to each other such that the second focal point 550 is at a point on the inner surface of the 3D reinforcement 10 that is designated as a starting point in an inner curing pattern. Next, the inner curing pattern and the outer curing pattern are performed. For the outer curing pattern, the lens 400 and/or the 3D reinforcement 10 are moved (e.g., relative to each other) such that the focal point 350 moves along the outer surface of the 3D reinforcement 10 according to the outer curing pattern. For the inner curing pattern, the emitter of the second energy source 500 and/or the 3D reinforcement 10 are moved (e.g., relative to each other) such that the second focal point 550 moves along the inner surface of the 3D reinforcement 10 according to the inner curing pattern. Sensors can be used to continuously monitor the curing of the additive manufacturing liquid 1 on the inner and/or outer surfaces of the 3D reinforcement 10.

After the inner and outer curing patterns have been completed successfully, a finished component or structure is formed, in which the 3D reinforcement 10 is integrated within, at least partially, the cured additive manufacturing liquid 1. Next, the emitter of the second energy source 500 is retracted from the hole 210 formed in the build plate. Next, the build plate 200, as well as the finished component attached thereto, is removed from the basin 2, as well as the remaining uncured additive manufacturing liquid 1 contained therein. Since the cured additive manufacturing liquid 1 may, after having been cured by the focused energy 340, be impervious to the remaining uncured additive manufacturing liquid 1, it may be necessary to drain any uncured additive manufacturing liquid 1 from the finished component after the build plate 200 and the finished component are removed from the basin 2. Finally, the finished component is removed from the build plate 200 and any necessary finishing steps are performed on the finished component as needed. These finishing steps include, optionally, any of exposing the finished component for final curing and trimming the finished part to remove any extraneous material based on the specification of the finished component.

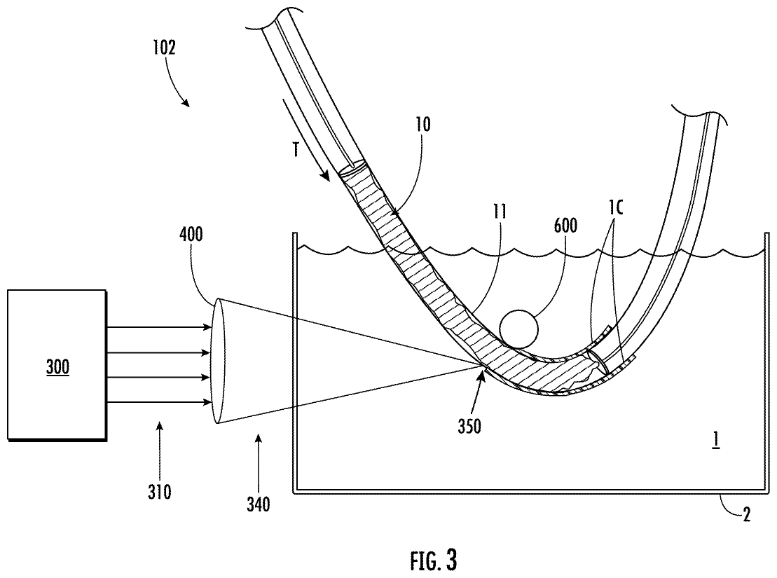

FIG. 3 is a side view of a third example embodiment of a system, generally designated 102, for directing energy, generally designated 310, from an energy source 300 to an additive manufacturing fluid, generally designated 1, for curing the additive manufacturing fluid 1 on and/or within a three-dimensional (3D) reinforcement 10 that is moving through the additive manufacturing fluid 1. The 3D reinforcement 10 is formed to have a prescribed geometry based on the component being manufactured. The 3D reinforcement 10 is then attached to a transport 11 (e.g., a chain, belt, a series of build plates 200, see FIGS. 1 and 2, that are attached to each other in an end-to-end manner, etc.). The transport 11 is arranged such that it passes around a roller 600. The roller 600 can be immersed within the additive manufacturing fluid 1 or external to the additive manufacturing fluid 1. However, in all cases the roller 600 is positioned such that at least the 3D reinforcement 10 is immersed in the additive manufacturing fluid 1 in order for the additive manufacturing fluid 1 to be cured in and/or on the 3D reinforcement 10. The additive manufacturing fluid 1 can be contained in a basin 2. The roller 600 can be an idler roller or a driven roller. As the 3D reinforcement 10 passes around the roller 600, the additive manufacturing fluid 1 is cured onto the 3D reinforcement 10 by exposure of the additive manufacturing fluid 1 to an energy source 300.

The additive manufacturing fluid 1 can be any suitable material for curing (e.g., changing from a liquid to a solid) by the energy source 300. For example, the additive manufacturing fluid 1 can be a liquid polymer. The type of additive manufacturing fluid 1 and the energy source 300 can be selected to complement each other, meaning that the energy source 300 must always be of a type that will cure (e.g., harden, solidify, or otherwise change from liquid to substantially solid or solid) the selected additive manufacturing fluid 1. The additive manufacturing fluid in a cured, or hardened, state is designated 1C.

In the example embodiment shown, the energy source 300 emits unfocused energy, generally designated 310, which is directed incident on a lens designated 340. During the curing process, the lens 400 is positioned such that the focused energy 340 has a focal point 350 that is within the basin 2. The basin 2 should be substantially transparent to the energy produced by the energy source 300, so that the basin 2 does not absorb the energy passing therethrough. During the curing process, a controller is used to control a position of the lens 400 so that the focal point 350 follows a curing pattern within the basin 2. In the example embodiment shown in FIG. 3, since the transport 11 is moving the 3D reinforcement past the focal point 350, the curing pattern may only be unidirectional (e.g., into the sheet, or in the direction perpendicular to the plane in which FIG. 3 is shown), such that the focal point is moved over the width of the 3D reinforcement 10 with sufficient speed to cure the additive manufacturing fluid 1 over the designated portion of (e.g., the entirety of) the outer surface of the 3D reinforcement 10. In instances in which the focal point 350 is sufficiently wide to be incident on the entire width of the 3D reinforcement 10 without requiring movement of the focal point 350, the curing pattern may be omitted or, in the alternative, deactivated or set to a stationary setting. The curing pattern is selected based on the shape (e.g., width) of the 3D reinforcement 10 and the component being manufactured. These aspects apply primarily to embodiments in which movement of the transport 11 is substantially continuous.

In some embodiments, the movement of the transport 11 can be in a stepped, or incremented, manner. In such instances, the curing pattern can instruct the controller to move the lens 400 to change the position of the focal point 350 according to the curing pattern, such that the focal point passes over designated portions of the 3D reinforcement 10 (e.g., corresponding to the entirety of the 3D reinforcement 10 on one of the build plates when the transport 11 comprises a plurality of build plates attached in an end-to-end manner) while the transport 11 is stationary. Thus, the controller can be used to apply the curing pattern for curing the additive manufacturing fluid 1 to the 3D reinforcement of each build plate of the transport 11 before the controller moves the transport 11 by a step (e.g., corresponding to a length of one of the build plates of the transport 11 in the transport direction T), at which point the controller will execute the curing pattern for the 3D reinforcement on the next build plate of the transport 11. In some instances, the 3D reinforcement 10 on some build plates of the transport 11 can be different from other 3D reinforcements 10 on other build plates of the transport 11. In such instances, the controller is configured to apply the appropriate curing pattern for each 3D reinforcement 10 on each build plate of the transport 11. The 3D reinforcement 10 on each build plate of the transport may be predefined or may be detected in a dynamic manner (e.g., using an image recognition algorithm) by one or more sensors (e.g., one or more cameras).

During the curing process, the curing pattern selected by the controller will generally control the position and angle of the lens 400 such that the focal point 350 is within the 3D reinforcement 10, on the outer surface of the 3D reinforcement 10, or on the outer surface of previously cured additive manufacturing fluid (e.g., that defines an outer surface of the 3D reinforcement 10) as the transport 11 moves the 3D reinforcement 10 through the focal point 350. The controller can, when the focal point 350 is defined as not being stationary, move the lens 400 so that the focal point 350 cures the additive manufacturing fluid 1 within and/or on the surface of the 3D reinforcement 10, so as to form a component or structure in which the cured additive manufacturing fluid 1 and the 3D reinforcement 10 are integrally formed with each other, meaning a monolithic or unitary construction in some instances. In some embodiments, the position of the focal point 350 within the basin 2 may be controlled by reflecting the focused energy 340 off of a reflective surface, such as a glass mirror, a polished metallic surface, etc.

The 3D reinforcement 10 has a shape and construction that is based on providing the component or structure being formed using the system 102 with a prescribed shape and mechanical properties. In the example embodiment shown in FIG. 3, the 3D reinforcement 10 is in the form of a generally woven or knitted pattern that extends substantially indefinitely in the direction of movement T of the transport 11, while also having a width (e.g., into the sheet, or in the direction perpendicular to the plane in which FIG. 3 is shown) and a thickness. This thickness can be negligible (e.g., when the 3D reinforcement 10 is in the shape of a flat sheet) or can be non-negligible (e.g., when the 3D reinforcement 10 has a shape, such as a U- or C-shaped profile, or when the 3D reinforcement 10 is formed from a mesh or has a layup construction). The 3D reinforcement 10 can be, for example and without limitation, made from polymeric fibers and/or mesh, natural fibers and/or mesh, metal fibers and/or mesh, and mixtures of any of these materials. The various polymeric, natural, and/or metal fibers and meshes can form, for example, a knitted or woven material. In some embodiments, the various polymeric, natural, and/or metal fibers and meshes can be assembled in a layup manner (e.g., a series of stacked layers) and/or via any suitable welding processes.

The energy 310 produced by the energy source 300 can be, for example and without limitation, ultraviolet light, laser light, electromagnetic waves, and the like. The lens 400 can be an optical lens and/or a magnetic lens. The energy source 300 can produce any types of beams having energy that can be focused into a focal point 350 to enable local curing of the additive manufacturing fluid 1 in a controllable manner. The 3D reinforcement 10 can be transparent, translucent, or opaque to the energy 310 emitted from the energy source 300.

The system 100 also comprises sensors that are used to continuously monitor the curing process within the basin 2. Non-limiting examples of such sensors include cameras, scattered radiation detectors, and the like.

Thus, a method of using the system 102 to cure an additive manufacturing liquid integrally with a 3D reinforcement to produce a component or structure via an additive manufacturing process can include the following steps. In a first step, the 3D reinforcement 10 is manufactured to have a prescribed geometry and construction. This 3D reinforcement 10 can have electrical and/or sensing functions. The 3D reinforcement 10 can be formed from any of polymer fibers and/or mesh, natural fibers and/or mesh, and/or metal fibers and mesh. The 3D reinforcement 10 can be formed in the manner of a preform structure, such as using any of the following techniques: knitting, weaving, laying-up layers, and/or welding. After the 3D reinforcement 10 has been manufactured, the 3D reinforcement 10 is attached to the transport 11 (e.g., to the individual build plates that define the transport 11). The transport 11 is then moved through the basin 2, as well as the additive manufacturing fluid 1 contained in the basin 2, such that the 3D reinforcement 10 is partially or entirely immersed within the additive manufacturing liquid 1 within the basin 2 during a curing process. In some instances, the transport 11 is also immersed in the additive manufacturing liquid 1. The 3D reinforcement 10 can be impervious to the additive manufacturing liquid 1 or porous, allowing the additive manufacturing liquid 1 to pass through the 3D reinforcement 10.

Next, the curing process is initiated by energizing an energy source 300 to provide energy 310, which is incident on a lens 400 that emits focused energy 340 that converges at a focal point 350 within the basin 2. The energy 310 emitted from the energy source 300 is of a type that will cure (e.g., harden, solidify, or otherwise change from liquid to substantially solid or solid) the additive manufacturing liquid 1 at the focal point 350. The additive manufacturing liquid 1 is cured at least on the outer surface of and/or within the 3D reinforcement 10. Examples of energy types provided by the energy source 300 include UV light, gamma rays, electronic beam, laser, etc. The lens 400 and/or the 3D reinforcement 10 are positioned relative to each other such that the focal point 350 is at a point on the surface of the 3D reinforcement 10 that is designated as a starting point in a curing pattern. Next, the lens 400 and/or the 3D reinforcement 10 are moved (e.g., relative to each other) such that the focal point 350 moves along the surface of the 3D reinforcement 10 according to the curing pattern. In some instances, the 3D reinforcement 10 can have a length or at least one dimension that exceeds the size of one build plate of the transport 11. Sensors can be used to continuously monitor the curing of the additive manufacturing liquid 1.

After the curing pattern has been completed successfully, a finished component or structure is formed, in which the 3D reinforcement 10 is integrated within, at least partially, the cured additive manufacturing liquid 1. Using the presently disclosed method, it is possible to manufacture large parts using at least one, or a plurality of, 3D reinforcement 10 shapes to manufacture a large part, such as, for example, a passenger door seal in a single build job. In some instances, the 3D reinforcement 10 has a width and/or cross-sectional shape that is constant along the length of the 3D reinforcement 10. In some instances, the 3D reinforcement 10 has a width and/or cross-sectional shape that is different along the length of the 3D reinforcement 10. After passing through the focal point 350, the transport 11, as well as the finished component attached thereto, continues moving in the transport direction T, emerging from the basin 2, as well as the remaining uncured additive manufacturing liquid 1 contained in the basin 2. Optionally, the method may comprise a step of draining any uncured additive manufacturing liquid 1 from the finished component after the portion of the transport 11 to which the finished component is attached emerges from the basin 2. Finally, each of the finished component is removed from the portion of the transport 11 to which such finished component is attached, and a series of finishing steps are performed on the finished component as needed. These finishing steps include, optionally, any of exposing the finished component for final curing and trimming the finished part to remove any extraneous material based on the specification of the finished component.

In any of the example embodiments disclosed herein, the 3D reinforcement 10 can be made of a material that reflects or absorbs the type of energy emitted from the energy source 300.

It is understood that the example embodiments disclosed herein are not limiting and do not restrict the subject matter disclosed herein. In particular, it will be evident to the person skilled in the art that the features described herein may be combined with each other arbitrarily, and/or various features may be omitted therefrom, without any resultant devices, systems, and/or methods deviating from the subject matter disclosed herein.

While at least one example embodiment of the present invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise.

1. A system for making a finished component having a three-dimensional (3D) reinforcement integrally formed within a cured additive manufacturing fluid via an additive manufacturing process, the system comprising:
a transport configured to have the 3D reinforcement attached thereto and to at least partially immerse the 3D reinforcement within the additive manufacturing fluid in an uncured state;
an energy source configured to emit energy to a focal point, the energy being configured to change the additive manufacturing fluid from the uncured state to a cured state; and
a controller configured to control a position of the focal point to pass over at least a portion of an outer surface of the 3D reinforcement according to a curing pattern, changing the additive manufacturing fluid from the uncured state to the cured state on the portion of the outer surface of the 3D reinforcement defined by the curing pattern as the curing pattern is executed by the controller.

2. The system of claim 1, wherein the transport comprises a build plate that suspends the 3D reinforcement attached thereto within the additive manufacturing fluid.

3. The system of claim 2, comprising a second energy source with an emitter configured to emit energy to a second focal point, the energy being configured to change the additive manufacturing fluid from the uncured state to the cured state, wherein:
the build plate comprises a hole; and
the emitter is configured to extend through the hole, into a volumetric region defined within the 3D reinforcement, for curing the additive manufacturing fluid over some or all of an inner surface of the 3D reinforcement.

4. The system of claim 1, wherein the transport comprises a plurality of build plates that are attached in an end-to-end manner, the transport being configured to sequentially immerse the 3D reinforcement attached to each of the plurality of build plates within the additive manufacturing fluid.

5. The system of claim 4, comprising:
a basin containing the additive manufacturing fluid in the uncured state; and
a roller configured to guide the plurality of build plates of the transport sequentially into the additive manufacturing fluid and through a region in the basin in which the energy is directed for curing the additive manufacturing fluid.

6. The system of claim 1, wherein the energy comprises one or more of ultraviolet light, laser light, electromagnetic waves, electronic beam, and gamma rays.

7. The system of claim 6, comprising a lens configured, when the energy is incident on the lens, to focus the energy to the focal point within the additive manufacturing fluid, so that the additive manufacturing fluid is changed from the uncured state to the cured state only at the focal point.

8. The system of claim 6, wherein the controller is configured to move the 3D reinforcement, the lens, and/or the energy source so that the focal point moves over some or all of an outer surface of the 3D reinforcement to cure the additive manufacturing fluid over the outer surface of the 3D reinforcement.

9. The system of claim 1, wherein the additive manufacturing fluid comprises a liquid polymer.

10. The system of claim 1, wherein:
the 3D reinforcement comprises polymeric fibers and/or mesh, natural fibers and/or mesh, metal fibers and/or mesh, and mixtures thereof; and
the 3D reinforcement is in a form of a knitted or woven fabric, a lay-up comprising a plurality of stacked layers, and/or as a welded structure.

11. A method for making a finished component having a three-dimensional (3D) reinforcement integrally formed within a cured additive manufacturing fluid via an additive manufacturing process, the method comprising:
providing a transport;
attaching the 3D reinforcement to the transport;
using the transport to at least partially immerse the 3D reinforcement within the additive manufacturing fluid in an uncured state;
emitting energy from an energy source to a focal point to change the additive manufacturing fluid from the uncured state to a cured state; and
controlling, using a controller, a position of the focal point to pass over at least a portion of an outer surface of the 3D reinforcement according to a curing pattern, changing the additive manufacturing fluid from the uncured state to the cured state on the portion of the outer surface of the 3D reinforcement defined by the curing pattern as the curing pattern is executed by the controller.

12. The method of claim 11, wherein the transport comprises a build plate that suspends the 3D reinforcement attached thereto within the additive manufacturing fluid.

13. The method of claim 12, wherein the build plate comprises a hole, the method comprising:
providing a second energy source with an emitter;
extending the emitter through the hole, into a volumetric region defined within the 3D reinforcement; and
emitting energy from the emitter to a second focal point to change the additive manufacturing fluid from the uncured state to the cured state over some or all of an inner surface of the 3D reinforcement.

14. The method of claim 11, wherein the transport comprises a plurality of build plates that are attached in an end-to-end manner, the method comprising using the transport to sequentially immerse the 3D reinforcement attached to each of the plurality of build plates within the additive manufacturing fluid.

15. The method of claim 14, comprising:
providing a basin containing the additive manufacturing fluid in the uncured state; and
using a roller to guide the plurality of build plates of the transport sequentially into the additive manufacturing fluid and through a region in the basin in which the energy is directed for curing the additive manufacturing fluid.

16. The method of claim 11, wherein the energy comprises one or more of ultraviolet light, laser light, electromagnetic waves, electronic beam, and gamma rays.

17. The method of claim 16, comprising:
providing a lens;
directing the energy from the energy source onto the lens; and
using the lens focus the energy to the focal point within the additive manufacturing fluid, so that the additive manufacturing fluid is changed from the uncured state to the cured state only at the focal point.

18. The method of claim 16, comprising using the controller to move the 3D reinforcement, the lens, and/or the energy source so that the focal point moves over some or all of an outer surface of the 3D reinforcement to cure the additive manufacturing fluid over the outer surface of the 3D reinforcement.

19. The method of claim 11, wherein the additive manufacturing fluid comprises a liquid polymer.

20. The method of claim 11, wherein:
the 3D reinforcement comprises polymeric fibers and/or mesh, natural fibers and/or mesh, metal fibers and/or mesh, and mixtures thereof; and
the 3D reinforcement is in a form of a knitted or woven fabric, a lay-up comprising a plurality of stacked layers, and/or as a welded structure.
